(19) United States
(12) Patent Application Publication
(10) Pub. No.: US 2003/0211252 A1
(43) Pub. Date: Nov. 13, 2003

(54) Method and apparatus for horizontal powder coating

(76) Inventor: Evan R. Daniels, Dallas, TX (US)

Correspondence Address: HAYNES AND BOONE, LLP, 901 MAIN STREET, SUITE 3100, DALLAS, TX, 75202, US

(21) Appl. No.: 10/144,170

(22) Filed: May 13, 2002

(51) Int. Cl. B05D 1/04; B05D 3/02; B05D 3/06

(52) U.S. Cl. 427/553; 118/620; 118/308; 427/558; 427/475; 427/180; 427/385.5

(57) ABSTRACT

An apparatus for powder coating has a coating chamber and a generally horizontal conveyor to electrically ground a article within the coating chamber. A powder dispenser distributes powder within the coating chamber to coat the article.

The present invention relates to powder coating and, more particularly to, an improved method of and apparatus for powder coating large or heavy items on a horizontal conveyor.

### BACKGROUND OF THE INVENTION

Powder coating has been used as an alternative to priming and painting many consumer products. The unique application characteristics of powder coatings provide superior consistency and uniformity of finish on these products without drips, runs, or bubbles. Powder coating provides tough, durable films, enhancing the quality appearance of these products. In general, performance properties such as impact resistance, flexibility, and corrosion resistance, of powder coatings are better than liquid paints. Powder coated products resist cracking, peeling, and marring during handling and normal service use.

Powder coating frequently costs less than priming and painting a product. Production costs are conserved through energy savings, labor costs, rework costs, reduced material usage, reduced waste disposal costs, and an increase in overall line efficiency. One advantage to manufacturers and consumers is that powder coated products have a superior quality finish at a reasonable cost.

Powder coating building materials is also more environmentally sound than painting. Environmental issues are a significant interest to the government and consumers. Unlike many primers and paints, powder coatings comply with environmental regulations. Primers and paints often contain VOC's, which can contribute to air pollution and, in some cases, ozone depletion. Powder coatings contain minimum amounts of VOC's and, therefore, may be perceived by the consumer to be environmentally friendly. Wet painting processes may also generate sludge, which must be disposed in hazardous waste landfills. This disposal increases the cost of the building products. Properly formulated powder coatings generate no hazardous waste. Unused or excess powder may be reclaimed and recycled, which also reduces overall product cost.

Typically, products that will be powder coated are manually hung on a grounded hanger within a powder coating booth. The hanger serves to electrically charge the product with a charge opposite to that of the powder. The powder, consequently, is attracted to the surface of the product when the powder is introduced into the powder coating booth. The powder on the product may then be cured to a durable and attractive finish.

This hanging process, however, is slow and labor intensive. Many types of products must be manually moved from a production line to the powder coating booth and hung by hand onto the hangers. The time required for moving and hanging the products decreases manufacturing efficiency and increases costs of production. Also, products may be dropped or damaged while they are being manually moved to and hung in the powder coating booth.

Furthermore, typical hangers and powder coating booths may not support or accommodate large or heavy products. Heavy products such as passage doors, for example, may bend the hanger and fall. This not only may cause damage to the heavy product and the resulting finish, but also increases production time.

It would, therefore, be desirable to have an improved method and apparatus for powder coating products that does not increase production time or increase the opportunity for damage to the products. It would also be desirable to have an improved method and apparatus for powder coating products that does not consume excessive labor resources. Further, it would be desirable to have an improved method and apparatus for powder coating large or heavy products that are not accommodated by conventional powder coating equipment.

### SUMMARY OF THE INVENTION

The present invention is an apparatus for powder coating a product. The apparatus has a coating chamber and a generally horizontal conveyor to electrically ground a product within the coating chamber. A powder dispenser distributes powder within the coating chamber to coat the product.

In one embodiment of the invention, a method of applying a powder coating has the step of horizontally conveying a product into a coating booth. Powder is distributed to the coating booth and the product is electrostatically charged to attract the powder. The powder is then cured to adhere to the product.

In another embodiment of the invention, a method of powder coating a product has the step of horizontally conveying the product into a coating chamber. A first surface of the product is coated with powder. The product is then rotated about an axis of the product to present a second surface of the product. The second surface of the product is then coated with powder. The powder on the first and second surfaces is then cured.

### BRIEF DESCRIPTION OF THE DRAWINGS

For a more complete understanding of the present invention, including its features and advantages, reference is now made to the detailed description of the invention, taken in conjunction with the accompanying drawings of which:

FIG. 1 is a schematic view of a horizontal powder coating oven that depicts an embodiment of the present invention;

FIG. 2 is detail view of a horizontal powder coating oven conveyor that depicts an embodiment of the present invention; and

FIG. 3 is a side view of a horizontal powder coating oven conveyor that depicts an embodiment of the present invention.

### DETAILED DESCRIPTION OF THE INVENTION

While the making and using of various embodiments of the present invention is discussed in detail below, it should be appreciated that the present invention provides many applicable inventive concepts that can be embodied in a wide variety of specific contexts. The specific embodiments discussed herein are merely illustrative of specific ways to make and use the invention, and do not delimit the scope of the invention.

A horizontal powder coating oven according to one embodiment of the present invention has many desirable features that were previously unavailable to those in the business of powder coating. Although methods and equipment for powder coating many products were known, economically powder coating large or heavy products presented several problems such as the difficulty of hanging the large or heavy products in a powder coating booth. Powder coating objects typically requires that a hanger ground the product so that the product and the powder have opposite electrical charges. This opposite charge uniformly attracts the positively charged powder to surface of the product where the powder may be cured. Curing the powder results in a desirable finish being formed on the product. In the case of large or heavy products such as molding or passage doors, however, hanging the product within the powder coating booth may be difficult or impossible. As will be described in more detail with reference to the figures, one embodiment of the present invention applies powder coat finishes to large or heavy objects.

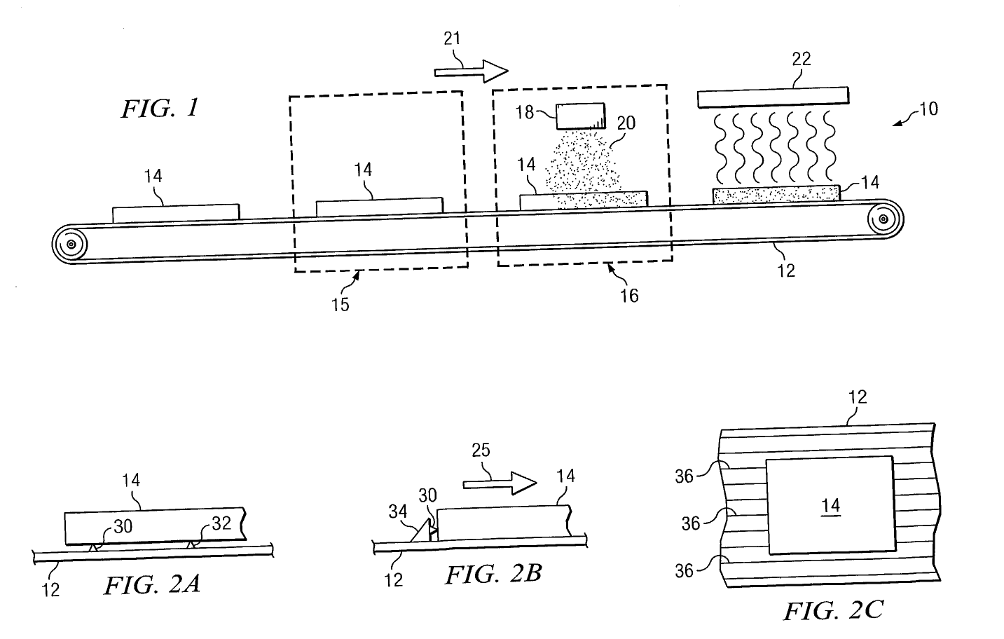

Referring now to the figures and, in particular to FIG. 1, a horizontal powder coating apparatus 10 has a conveyor 12 that conveys an article 14. The article 14 may be preheated in a preheater 15 to prepare the article 14 for powder coating. Preheating the article 14, in some instances, promotes better adhesion of the powder coating to the article 14. The article 14 is then conveyed through a powder coating booth 16. A powder dispenser 18 may be located within the powder coating booth 16 and dispenses a powder 20 to the article 14. The conveyor 12 conveys the article 14 through the powder coating booth 16 in the direction indicated by arrow 21. The conveyor 12 is in electrical communication with the article 14 and oppositely charges the article 14 relative to the powder 20 to attract the powder 20 to the surface of the article 14. A curing device 22 cures the powder 20 after the powder 20 has been applied to the article 14.

The conveyor 12 may be a typical endless belt-type conveyor that is known to those having ordinary skill in conveyors. The conveyor 12 conveys one or more articles 14 through the powder coating booth 16. The conveyor 12 may be configured to electrically charge the article 14 by one of several methods, which are described in greater detail with reference to FIGS. 2A-2C below. Multiple articles 14 may be loaded onto the conveyor 12 and conveyed through the powder coating booth 16 at a relatively high conveyor speed to continuously apply the powder 20 to the articles 14. Those having ordinary skill in powder coating will be aware that conveyor speed may be limited by the speed at which a desired volume of powder 20 may be deposited or applied to the article 14. Additionally, the conveyor speed may be limited by how fast the applied powder 20 may be cured.

The powder coating booth 16 may be a typical powder coating booth for powder coating operations that is known to those having ordinary skill in powder coating. The powder coating booth 16 may be configured to accommodate large, flat or heavy articles 14 that are not easily hung from conventional powder coating racks. The powder coating booth 16, may, for example, be configured to accept one or more passage doors in a generally horizontal orientation. The powder dispenser 18 may be a typical dispenser known to those having ordinary skill in powder coating, such as the corona method dispenser or the triboelectric dispenser, for example. Other methods of applying powder 20 to the article 14 will be apparent to those having ordinary skill in powder coating.

The powder 20 may be, for example, powder of the type described in U.S. Pat. Nos. 5,907,020 or 6,077,610 to Correll et al., U.S. Pat. No. 5,721,052 to Muthiah et al, or U.S. Pat. No. 5,714,206 to Daly et al. These patents are all assigned to Morton International, Inc. and disclose powder coating systems that are suitable for coating wood-based products. The powder 20 may be configured to produce a smooth or a textured finish on the article 14. In some instances, a wood grain texture, for example, may be produced by configuration of the powder 20. Other desirable finish characteristics will be apparent to those having ordinary skill in powder coating. Alternatively, the powder 20 may be a conventional powder that is suitable for coating metals and other materials.

The curing device 22, which may incorporate an infrared, ultraviolet, or thermal curing process, for example, cures the powder 20 after the powder 20 is applied to the article 14. As discussed above with reference to coating speed, the conveyor speed may also be limited by the rate that the curing device 22 is capable of curing the powder 20 on the article 14.

The article 14 may be made from a variety of wood or wood-based materials such as particleboard, MDF, and the like. The article 14 may also be made from a combination of these materials. The powder coating apparatus and process described herein may also be used for articles 14 made from metals, alloys, ceramics, composites, and the like. Although the horizontal powder coating apparatus 10 is particularly suited for powder coating articles 14 that are impractical or inefficient to hang in conventional powder coating booths, the horizontal powder coating apparatus 10 may also be used to quickly and efficiently powder coat articles 14 that might otherwise be powder coated in conventional equipment. For example, the article 14 may be a passage door, a cabinet door, a shutter, molding, a banister, a baluster or other wooden or wood-based product, and the like.

Because both lower and upper surfaces of many articles 14 may require coating, the article 14 may be turned on the conveyor 12 while passing through the powder dispenser 18. Alternatively, the conveyor 12 may be configured to allow powder 20 to be applied through the conveyor 12 to the surface of the article 14 that is in electrical contact with the conveyor 12. One or more curing devices 22 may also be disposed to cure the powder 20 on multiple or opposite surfaces of the article 14.

The orientation of the article 14 may be varied according to the configuration of the conveyor 12, the powder coating booth 16, or the curing device 22. Additionally, the orientation of the article 14 may be adjusted or changed during the powder coating process.

In a typical powder coating process, a product to be powder coated is hung from a conductive rod. A round hole in the product accepts the rod, which is slightly smaller in diameter than the hole, and secures the product during the process. After the powder coating process, however, the hole in the product remains and must be filled unless the hole is not located on a visible surface.

Turning now to FIGS. 2A-2C, several different interfaces may be used to securely hold and electrically charge the article 14 during the powder coating process. As depicted in FIG. 2A, the conveyor 12 has one or more contacts 30 to electrically engage the article 14. The contacts 30 may be made from a conductive material and isolate the article 14 from the conveyor 12. An electrical charge may be delivered through conductors (not shown) in the conveyor 12, through the contact 30 and into the article 14. Because the charge is opposite from the charge of the powder 20, the powder 20 is attracted to the article 14 and is cured to the surface of the article 14 in subsequent steps.

In this particular embodiment, the weight of the article 14 maintains the electrical connection between the article 14 and the contact 30. A support 32 may be used to maintain the article 14 at a uniform height above the conveyor 12. Powder 20 may then be more easily and uniformly distributed to the supported side of the article 14. The interface points between the article 14 and the contacts 30 may be small enough to not adversely affect the surface finish of the supported side of the article 14.

Turning now to FIG. 2B, the contact 30 may be housed in a clamp 34. The clamp 34 pushes the contact 30 into electrical connection with the article 14 as the conveyor 12 moves in the direction of arrow 25. Several clamps 34 and contacts 30 may be located on the conveyor 12 to electrically charge multiple articles 14.

With reference to FIG. 2C, the surface of the conveyor 12 may have one or more embedded wires 36. The wires 36 may slightly extend from the surface of the conveyor 12 to electrically contact a surface of the article 14. The wires 36 may also extend generally circumferentially around the surface of the conveyor 12. Other methods of electrically charging the article 14 will be apparent to those having ordinary skill in powder coating.

Whereas the invention has been shown and described in connection with the preferred embodiment thereof, it will be understood that many modifications, substitutions and additions may be made which are within the intended broad scope of the appended claims. There has therefore been shown and described an improved powder coating system that accomplishes at least all of the above stated advantages.

What is claimed is:

1. A powder coating apparatus for wood-based articles comprising:
a coating chamber;
a generally horizontal conveyor to electrically charge a article within the coating chamber;
a powder dispenser to distribute powder within the coating chamber to the article.

2. The apparatus of claim 1, wherein the generally horizontal conveyor conveys the article from production machinery into the coating chamber.

3. The apparatus of claim 1, wherein the generally horizontal conveyor conveys the article to a curing device from the coating chamber.

4. The apparatus of claim 1, wherein the generally horizontal conveyor electrically charges the article at a distinct point.

5. The apparatus of claim 1, wherein one or more pins connected to the generally horizontal conveyor engage and electrically charges one or more articles on the conveyor.

6. The apparatus of claim 1, wherein one or more clamps connected to the generally horizontal conveyor engage an edge of the article and electrically charge the article on the conveyor.

7. The apparatus of claim 1, further comprising a curing device to cure the powder that is distributed to the article.

8. The apparatus of claim 7, wherein the curing device is an infrared curing device.

9. The apparatus of claim 7, wherein the curing device is an ultraviolet curing device.

10. A method of applying a powder coating to wood-based articles comprising the steps of:
horizontally conveying a article into a coating booth;
distributing powder to the coating booth;
electrostatically charging the article to attract the powder; and
curing the powder to adhere to the article.

11. The method of claim 10, wherein the step of curing the powder is by thermal curing.

12. The method of claim 10, wherein the step of curing the powder is by infrared light.

13. The method of claim 10, wherein the step of curing the powder is by ultraviolet light.

14. The method of claim 10, wherein the article is selected from the group of passage doors, cabinet doors, shutters, molding, banisters or balusters.

15. The method of claim 10, wherein the article is horizontally conveyed into the coating booth using an endless belt.

16. The method of claim 15, wherein the step of electrostatically charging the article is by engaging the article with pins, the pins electrically connected to the endless belt.

17. The method of claim 15, wherein the step of electrostatically charging the article is by engaging the article with a clamp, the clamp electrically connected to the endless belt.

18. The method of claim 10, wherein the article is horizontally conveyed from production machinery.

19. The method of claim 10, further comprising the step of conveying the article to a subsequent manufacturing process.

20. A method of powder coating a wood-based article comprising the steps of:
horizontally conveying the article into a coating chamber;
coating a first surface of the article with powder;
rotating the article about an axis of the article to present a second surface of the article;
coating the second surface of the article with powder; and
curing the powder on the first and second surfaces.
